(19) United States
(12) Patent Application Publication
(10) Pub. No.: US 2007/0294457 A1
(43) Pub. Date: Dec. 20, 2007

(54) USB wireless network drive

(76) Inventors: Alexander Gantman, Poway, CA (US); Jack Steenstra, San Diego, CA (US)

Correspondence Address: QUALCOMM INCORPORATED, 5775 MOREHOUSE DR., SAN DIEGO, CA, 92121, US

(21) Appl. No.: 11/454,408

(22) Filed: Jun. 16, 2006

(51) Int. Cl. G06F 13/20

(52) U.S. Cl. 710/313

(57) ABSTRACT

A universal serial bus (USB) device is provided that includes a USB interface that mimics the operation of a typical USB drive. The USB device provides identification information through its USB interface indicating that it is a storage device. In reality, the USB device does not include a USB drive or storage but rather a communication interface, such as a wired or wireless network interface, that allows the USB device to autonomously connect to and/or map a networked drive. This allows the USB device to establish a secure communication link to a remote storage device over the communication interface. Thus, the USB device allows a terminal to transparently connect to a remote network drive via a USB port, while the remote network drive appears as a local USB drive to the terminal.

### BACKGROUND

1. Field

Various embodiments of the invention pertain to universal serial bus devices and more specifically to a device that mounts a remote storage device over a communication interface and presents the remote storage device as a local storage device over a universal serial bus interface.

2. Background

Computer interconnectivity has become widespread and, with it, security weaknesses have been exposed that make computers vulnerable to intruders. Security holes or bugs in operating systems, network protocols, and/or applications are often exploited to obtain unauthorized access to information in a computer. For example, a computers connecting to the internet are susceptible to unauthorized access via security weaknesses of the operating system or network protocol employed. Additionally, the information transmitted from the computer over the internet is also susceptible to unauthorized access while in transit. Thus, connecting a computer to the internet makes it vulnerable to intruders seeking access to computer resources or information stored in or transmitted by the computer.

Computer users who travel or telecommute often have a need to remotely access corporate resources, such as corporate data, applications, and/or network drives, at a corporate data center. However, connecting to corporate resources either wired or wirelessly over the internet is not always possible. For instance, the user's computer may not be able to find an internet connection at a current location. Even when an internet connection is available to the user, the user must often undertake burdensome steps to setup and/or connect to corporate resources. Moreover, additional security mechanisms may need to be implemented to guarantee the integrity and protection of the user's computer and data transmitted from/to the user's computer. For instance, virtual private networks (VPN) and/or security software may be used, but such security mechanisms typically require user configuration and frequent updates to provide adequate protection. Unless the VPN is properly protected and/or the security software updated regularly, the computer is vulnerable to unauthorized intrusion.

Thus, a convenient and/or secure way is needed to permit remote computers to access corporate data and/or network drives with minimal user interaction.

### SUMMARY

A universal serial bus (USB) device is provided comprising (a) a USB interface, (b) a communication interface communicatively coupled to the USB interface, and (c) a circuit coupled to the USB interface and the communication interface. The circuit may be configured to (1) provide identification information through the USB interface indicating that the USB device is a storage device, (2) establish a communication link to a remote storage device over the communication interface, and/or (3) transmit data between the communication interface and USB interface to make the remote storage device appear as a local storage device over the USB interface. The communication interface may be a wireless communication interface through which the universal serial bus device can access a wireless network. The circuit may also be configured to (1) establish a virtual private network tunnel with a remote server through which the universal serial bus device can communicate with the remote storage device and/or (2) map a remote network drive or folder that appears as the local device over the USB interface. The universal serial bus device may also include a limited use storage device coupled to the circuit and configured to store internal configuration information for the USB device. The limited use storage device stores a security key to secure the communication link, and/or network connectivity information to assist in establishing the secure communication link

In some implementations, the circuit is further configured to (1) obtain a software patch for the USB device, and/or (2) update internal information of the USB device based on the software patch. Alternatively, the circuit may be configured to (1) obtain a software patch for a terminal coupled to the USB interface, and/or (2) transmit the software patch the terminal via the USB interface.

A method is also provided for operating a universal serial bus (USB) device. Identification information is provided through a USB interface indicating that the USB device is a storage device. A communication link is established to a remote storage server over a communication interface. A remote storage device is mapped via the communication link with the storage server. Data is transmitted between the communication interface and USB interface to make the remote storage device appear as a local storage device over the USB interface. A security key is stored in the USB device, wherein the security key is used to establish the communication link. Network connectivity information may be stored in the USB device, wherein the network connectivity information is used to connect to the remote storage device.

In some implementations, a software patch for the USB device is obtained and internal information of the USB device is updated based on the software patch. Alternatively, a software patch for a terminal coupled to the USB interface may be obtained, and the software patch is transmitted to the terminal via the USB interface.

Yet another implementation provides a processor having (a) a universal serial bus (USB) interface, (b) a communication interface communicatively coupled to the USB interface, and (c) a processing circuit coupled to the USB interface and the communication interface. The circuit is configured to (1) provide identification information through the USB interface indicating that the USB device is a storage device, (2) establish a secure communication link to a remote storage device over the communication interface, and (3) transmit data between the communication interface and USB interface to make the remote storage device appear as a local storage device over the USB interface.

### BRIEF DESCRIPTION OF THE DRAWINGS

FIG. 1 is an example system in which a USB device that mimics a flash drive over one interface and a network connection over a second interface operates.

FIG. 2 is an example small form factor USB device that is configured to mimic a local storage drive over a USB interface and connect to a remote storage device over a different communication interface.

FIG. 3 illustrates an example of how a USB device, such as USB device, may be configured to operate.

FIG. 4 illustrates an example method of operating a USB device to mimic a local storage drive over a USB interface and connect to a remote storage device over a different communication interface.

FIG. 5 illustrates an example method in which a USB device may be updated.

FIG. 6 is a block diagram illustrating yet another example of a USB device that delivers software updates or upgrades to a mobile terminal.

FIG. 7 illustrates an example of a USB device embodying one or more novel features.

### DETAILED DESCRIPTION

In the following description, specific details are given to provide a thorough understanding of the embodiments. However, it will be understood by one of ordinary skill in the art that the embodiments may be practiced without these specific details. For example, circuits may not be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels, and various other mediums capable of storing, containing, or carrying instruction(s) and/or data.

Furthermore, embodiments may be implemented by hardware, software, firmware, middleware, microcode, or a combination thereof. When implemented in software, firmware, middleware, or microcode, the program code or code segments to perform the necessary tasks may be stored in a machine-readable medium such as a storage medium or other storage means. A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others.

One feature provides a universal serial bus (USB) device that includes a USB interface that mimics the operation of a typical USB drive. In reality, the USB device does not include a USB drive but rather a communication interface, such as a wired or wireless network interface, that allows the USB device to connect to and/or map a networked drive. Thus, the USB device allows a computer to transparently connect to a remote network drive via a USB port, while the remote network drive appears as a local USB drive to the computer.

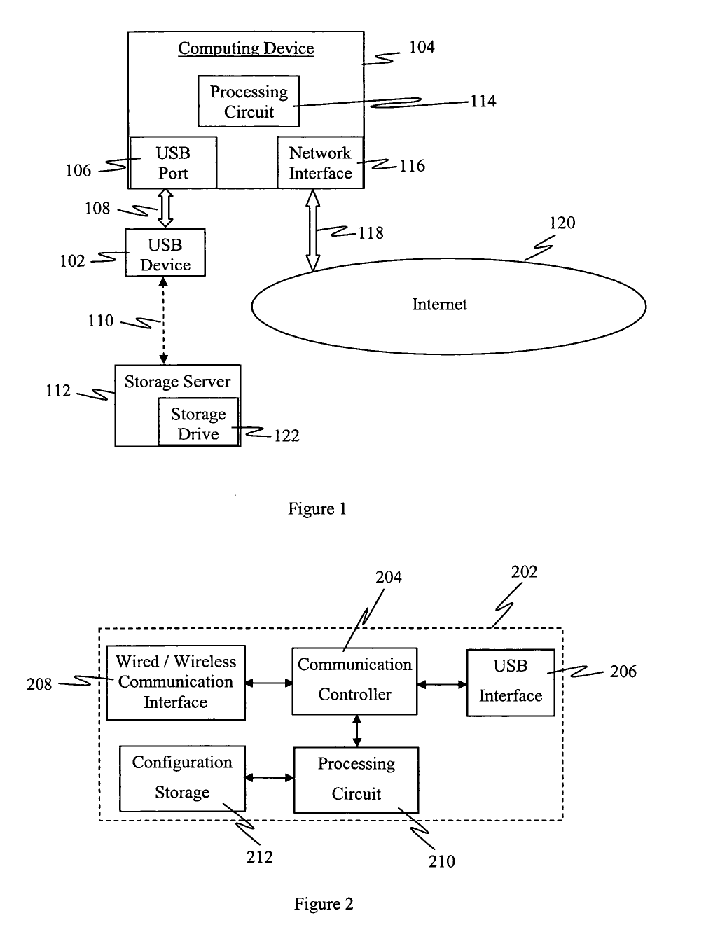

FIG. 1 is a block diagram illustrating an example system in which a USB device that mimics a flash drive over one interface and a network connection over a second interface. The USB device 102 includes a USB interface to couple to a USB port 106 of a computing device 104 (e.g., computer, laptop, mobile terminal, handheld device, etc.) and establish a first communication link 108 therewith. When coupled to the USB port 106, USB device 102 is configured to appear or present itself as a storage device (e.g., flash drive, etc.) to the operating system of the computing device 104. This may be achieved by configuring the USB device 102 descriptors/identifiers and signaling to indicate that it is a storage device (e.g., flash drive, etc.) when coupled to USB port 106. In this manner, USB device 102 mimics the operation of a storage device.

USB device 102 also includes another communication interface over which it can establish a second communication link 110 to communicate with a storage server 112 and/or data center (e.g., network drive or storage device). Storage server 112 may include one or more storage drives 122. Through this communication interface, USB device 102 may send data to and/or receive data from storage server 112 and/or storage drive 122. Circuitry in USB device 102 transfers data from first communication link 108 to second communication link 110 and vice versa. In performing data transfers between its USB interface and communication interface, USB device 102 may convert transmissions between these two interfaces to comply with the signal levels, packet sizes, data rates, and/or communication protocols expected by each interface.

Computing device 104 may include a processing circuit 114 (e.g., processor, etc.), USB port 106, and a network interface 116 through it is capable of establishing a link 118 to a network or the internet 120. Rather than using its network interface 116 and the internet 120 to access a remote data storage device, computing device 104 can access storage server 112 via its USB port 106 and USB device 102. Thus, instead of using the network interface 116 and communication link 118 to the internet 120, which exposes computing device 104 to intruders, a direct and secure link to the storage server 112 is used via USB device 102.

When coupled to computing device 104, USB device 102 establishes the second communication link 110 to storage server 112 (e.g., one or more network drives 122, etc.) and mounts storage drive 122 as a local drive on computing device 104. Once coupled to computing device 104, USB device 102 may operate transparently, without significant (or any) user interaction to setup or configure its operation, communication link to storage server 112, or mapping of storage drive 122.

In one implementation, the second communication link 110 is not an open network connection so it is very secure. It is secure in that it is not an open network connection. By using the USB device 102, the operating system of computing device 104 is not exposed to a direct connection to the internet, thereby reducing its exposure to viruses and/or attacks. To establish this secure second communication link 110, USB device 102 may be configured to transparently setup a secure virtual private network (VPN) to the storage server 112. This avoids the need and complexity of configuring and setting up a VPN tunnel on the computing device 104. Instead, USB device 102 can simply be plugged into USB port 106 to make computing device 104 perceive that storage drive 122 is mounted as a local storage drive.

One feature of using the USB device 102 is that the information stored in the network servers, remote storage drives 112 and/or folders may be backed up in a single process rather than having to access a plurality of computing devices individually to backup such information. Additionally, because the storage drive 122 is mapped via the USB device 102, the storage capacity of the storage drive 122 may be increased as needed without changing the computing device 104.

FIG. 2 is a block diagram illustrating an example small form factor USB device 202 that is configured to mimic a local storage drive over a USB interface and connect to a remote storage device over a different communication interface. USB device 202 includes a communication controller 204 that manages communications between a USB interface 206 and a wired or wireless communication interface 208. The wired or wireless communication interface 208 may include a modem, transceiver, receiver, and/or transmitter that allows USB device 202 to transmit and/or receive information to/from external or remote devices over the communication interface 208. A processing circuit 210 may be coupled to the communication controller 204 to configure the communication controller 204 and manage the operations of the USB device 202. A small configuration (e.g., form factor) storage device 212 may store identification/configuration information, security protocols, and/or security keys, software, or patches which the processing circuit 210 can use to perform the operations of USB device 202. The storage device 212 is not accessible by outside devices but may be used by USB device 202 for storing its own information or as a communication buffer. USB device 202 may be powered over the USB interface 206. When plugged into a USB port, USB device 202 recognizes that it is connected to another device. It then provides information over the USB interface 206 indicating that the USB device is a local storage drive.

USB device 202 may be configured with the necessary contact information (e.g., IP address, communication channel, server address, etc.) to autonomously and transparently establish a secure communication link over communication interface 208 when plugged into a USB port through USB interface 206. In various implementations, the contact information may be embedded in configuration storage device 212 during manufacturing or it may be configured by a user employing a utility application. This contact information associates a particular USB device 202 with one or more specific remote network servers, remote storage drives and/or folders. The secure communication link permits USB device 202 to map the remote network servers, remote storage drives and/or folders to be accessible via USB interface 206 as local devices. In this manner, USB device 208 may transparently mount a remote storage drive as a local storage drive. USB device 202 performs the operations without the need of user input from the device connected to USB interface 206. USB device 202 may also be configured with multiple levels of security and/or access by using keys or passwords to access particular remote storage drives and/or folders.

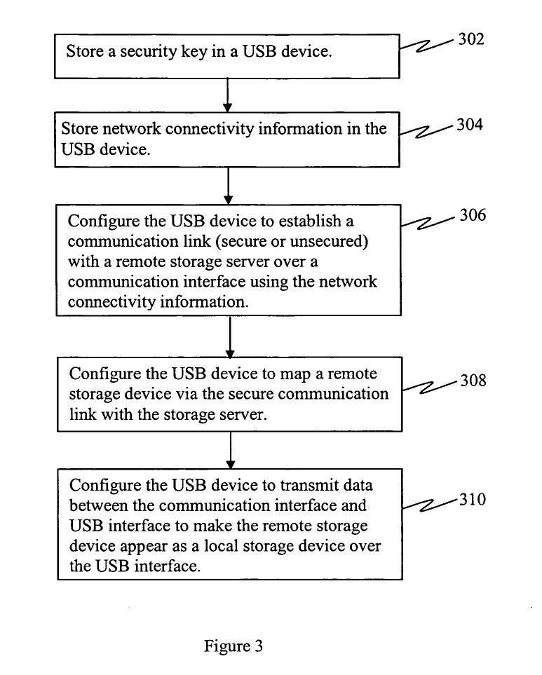

FIG. 3 illustrates an example of how a USB device, such as USB device 202, may be configured to operate. A security key is stored in the USB device 302. The security key may be stored in a limited use storage device (e.g., configuration storage device 212 in FIG. 2) that is available only to the USB device for configuration information and/or as a transmission buffer. Such security key may be used to safeguard transmissions to and/or from the USB device. The security key may be provided at manufacturing of the USB device or by the user during a setup stage. Network connectivity information may also be stored in the USB device 304. This allows the USB device to establish a communication link (secured or unsecured) with a remote storage server over a communication interface (e.g., FIG. 2, interface 206) using the network connectivity information 306. Such network connectivity information may indicate a particular network and/or storage server address with which to communicate. The USB device may also be configured to map a remote storage device via the secure communication link with the storage server 308. Once a storage device (e.g., network drive or folder) is mapped, USB device may transmit data between the communication interface (e.g., FIG. 2, interface 208) and USB interface (e.g., FIG. 2, interface 206) to make the remote storage device appear as a local storage device over the USB interface (e.g., FIG. 2, interface 206) 310.

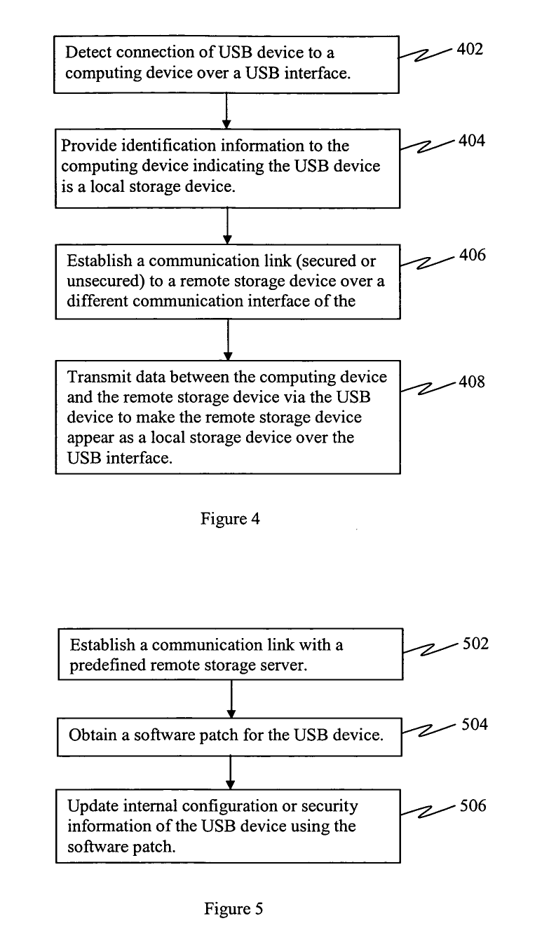

FIG. 4 illustrates an example method of operating a USB device (e.g., FIG. 2, USB device 202) to mimic a local storage drive over a USB interface and connect to a remote storage device over a different communication interface. Connection of a USB device to a computing device over a USB interface is detected 402. This may be done by simply determining when the USB interface has been coupled to a USB port. Identification information is then provided to the computing device indicating the USB device is a local storage device 404 (e.g., flash drive, etc.). A communication link (secured or unsecured) to a remote storage device is established over a different communication interface of the USB device 406. For example, in FIG. 2, processing circuit 210 retrieves information from configuration storage device 212 and uses that information to establish a secure communication link over communication interface 208 to a remote storage server or storage drive. Processing circuit 210 may establish a secure virtual private network with a remote server through which the USB device 202 can communicate with a network storage drive.

Data is may be transmitted between the computing device and the remote storage device via the USB device to make the remote storage device appear as a local storage device over the USB interface 408. This may be done by the USB device mimicking the operation of a storage device through the USB interface while transparently connecting to the remote storage device via the communication interface. For example, in FIG. 2, communication controller 204 is configured to transmit information between USB interface 206 and communication interface 208 transparent to an external device coupled to USB interface 206. That is, as perceived through USB interface 206, USB device 202 appears as a local storage drive via USB interface 206. In this manner, the remote storage device appears as a local storage device over the USB interface.

FIG. 5 illustrates a method in which a USB device may be updated according to one implementation. The USB device may include internally-used software, configurations, and/or keys used to operate the USB device and establish communications with external devices. One feature provides for software upgrades, patches, and/or virus detection/definition files to be downloaded to USB device and stored in configuration storage device. A communication link is established with a predefined remote storage server 502. The USB device then obtains a software patch 504 (via either its USB interface or communication interface). For example, a predefined folder on a remote storage device (reached via the remote storage server) may be used as a default location from where the USB device checks and retrieves upgrades, patches, and/or virus definitions. The USB device then updates internal configuration or security information of the USB device using the software patch 506. This feature permits a service provider or user to upgrade the features of the USB device.

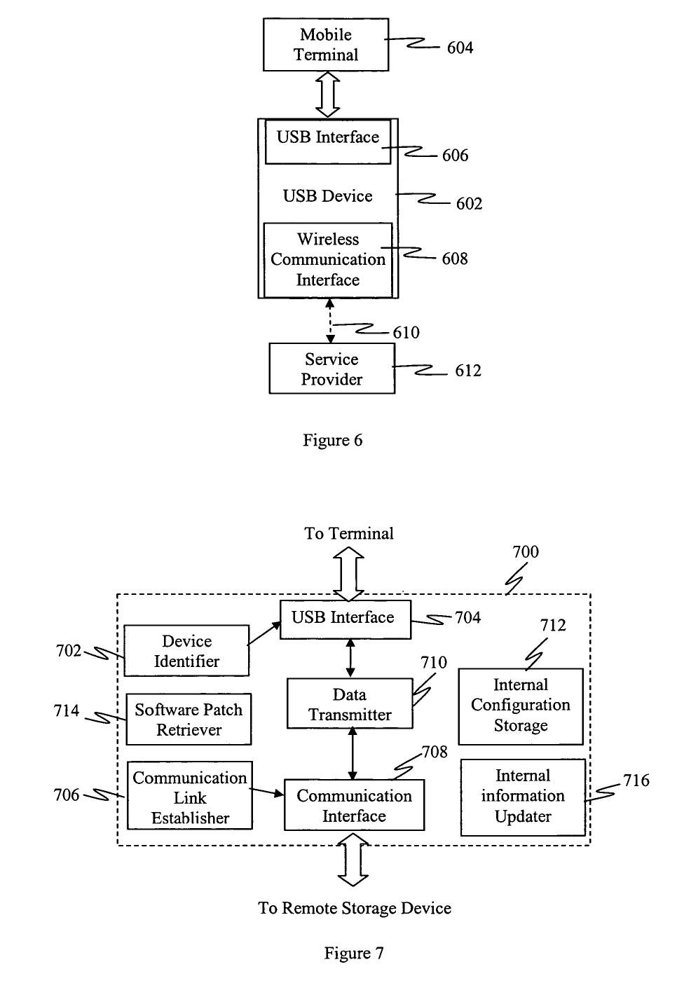

FIG. 6 is a block diagram illustrating yet another example of a USB device 602 that delivers software updates or upgrades to a mobile terminal 604. USB device 602, having a USB interface 606 and a wireless communication interface 608, is electrically coupled to mobile terminal 604. Mobile terminal 604 may be a cellular phone, a digital camera, a computer, a personal digital assistant, etc., having a USB port over which it can received software patches or updates.

USB device 602 may be configured to negotiate a communication link 610 with a service provider 612 either on-the-fly or by a previous arrangement with the service provider 612. Various communication standards (e.g., GSM, UMTS, IXRTT, GPRS, etc.) may be employed by USB device 202 to establish communication link 610 with service provider 612.

When plugged into mobile terminal 604, USB device 602 is configured deliver a software patch, updates, security upgrades, etc., to the mobile terminal 604 via USB interface 606. USB device 602 may receive the software patches, updates, security upgrades, etc., over the wireless communication interface 608 via communication link 610 and either store it internally or transmit it to the USB interface 606 for updating mobile terminal 604. This allows mobile devices having a USB port to be updated via an independent communication link via USB device 602.

One or more of the components, steps, and/or functions illustrated in FIGS. 1, 2, 3, 4, 5 and/or 6 may be rearranged and/or combined into a single component, step, or function or embodied in several components, steps, or functions without departing from the invention. Additional elements, components, steps, and/or functions may also be added without departing from the invention. The apparatus, devices, and/or components illustrated in FIGS. 1, 2, and/or 6 may be configured to perform one or more of the methods, features, or steps described in FIGS. 3, 4, and/or 5. Also, one or more processors may be implemented and configured to carry out the methods, features, or steps described in FIGS. 3, 4, and/or 5. Similarly, one or more machine readable mediums may be implemented and configured to store instructions to carry out the methods, features, or steps described in FIGS. 3, 4, and/or 5.

Thus, those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

It should be noted that the foregoing embodiments are merely examples and are not to be construed as limiting the invention. For instance, while some of the examples describe a USB interface (e.g., USB interfaces 206 in FIG. 2), other types of interfaces may be used in different implementations.

For example, FIG. 7 illustrates an example of a universal serial bus (USB) device 700 including a device identifier 702 configured to provide identification information through a USB interface 704 indicating that the USB device 700 is a storage device, a communication link establisher 706 configured to establish a communication link to a remote storage device over a communication interface 708, and a data transmitter 710 configured to transmit data between the communication interface 708 and USB interface 704 to make the remote storage device appear as a local storage device over the USB interface 704. The USB device 700 may optionally also include an internal configuration storage 712 configured to store internal configuration information for the USB device 700, a software patch retriever 714 configured to obtain software patch for the USB device 700, and an internal information updater 716 configured to update internal information of the USB device 700 based on the software patch. The software patch retriever 714 may be coupled to the USB interface 704 and the software patch may be transmitted to the terminal via the USB interface 704. It should be noted that one or more elements of USB device 700 may be rearranged and/or combined without affecting the operation of the device. Also, additional elements, components, steps, and/or functions may also be added without departing from the invention.

Accordingly, a USB device may comprise means for providing identification information through a USB interface indicating that the USB device is a storage device; means for establishing a communication link to a remote storage device over a different communication interface; and means for transmitting data between the communication interface and USB interface to make the remote storage device appear as a local storage device over the USB interface. The USB device may further comprise means for storing internal configuration information for the USB device. The USB device may further comprise means for obtaining a software patch for the USB device; and means for updating internal information of the USB device based on the software patch. The USB device may further comprise means for obtaining a software patch for a terminal coupled to the USB interface; and means for transmitting the software patch the terminal via the USB interface.

Here, the means for providing identification information may comprise the device identifier 702, the means for establishing a communication link may comprise communication link establisher 706, and the means for transmitting data may comprise the communication interface 708, as shown in FIG. 7. Moreover, the means for storing internal configuration information may comprise the internal configuration storage 712, the means for obtaining a software patch may comprise the software patch retriever 714, and the means for updating internal information may comprise internal information updater 716.

Therefore, the description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A universal serial bus (USB) device comprising:
a USB interface;
a communication interface communicatively coupled to the USB interface; and
a circuit coupled to the USB interface and the communication interface, the circuit configured to
provide identification information through the USB interface indicating that the USB device is a storage device,
establish a communication link to a remote storage device over the communication interface, and
transmit data between the communication interface and USB interface to make the remote storage device appear as a local storage device over the USB interface.

2. The universal serial bus device of 1 wherein the circuit is further configured to establish a virtual private network tunnel with a remote server through which the universal serial bus device can communicate with the remote storage device.

3. The universal serial bus device of 1 wherein the communication interface is a wireless communication interface through which the universal serial bus device can access a wireless network.

4. The universal serial bus device of 1 wherein the circuit is further configured to map a remote network drive that appears as the local device over the USB interface.

5. The universal serial bus device of 1 wherein the circuit is further configured to map a remote network folder that appears as the local device over the USB interface.

6. The universal serial bus device of 1 further comprising:
a limited use storage device coupled to the circuit and configured to store internal configuration information for the USB device.

7. The universal serial bus device of 6 wherein the limited use storage device stores a security key to secure the communication link.

8. The universal serial bus device of 6 wherein the limited use storage device stores network connectivity information to assist in establishing the secure communication link

9. The universal serial bus device of 1 wherein the circuit is further configured to
obtain a software patch for the USB device; and
update internal information of the USB device based on the software patch.

10. The universal serial bus device of 1 wherein the circuit is further configured to
obtain a software patch for a terminal coupled to the USB interface; and
transmit the software patch the terminal via the USB interface.

11. A universal serial bus (USB) device comprising:
means for providing identification information through a USB interface indicating that the USB device is a storage device;
means for establishing a communication link to a remote storage device over a different communication interface; and
means for transmitting data between the communication interface and USB interface to make the remote storage device appear as a local storage device over the USB interface.

12. The universal serial bus device of 11 further comprising:
means for storing internal configuration information for the USB device.

13. The universal serial bus device of 11 further comprising:
means for obtaining a software patch for the USB device; and
means for updating internal information of the USB device based on the software patch.

14. The universal serial bus device of 11 further comprising:
means for obtaining a software patch for a terminal coupled to the USB interface; and
means for transmitting the software patch the terminal via the USB interface.

15. A method for operating a universal serial bus (USB) device comprising:
providing identification information through a USB interface indicating that the USB device is a storage device;
establishing a communication link to a remote storage server over a communication interface;
mapping a remote storage device via the communication link with the storage server; and
transmitting data between the communication interface and USB interface to make the remote storage device appear as a local storage device over the USB interface.

16. The method of 15 further comprising:
storing a security key in the USB device, wherein the security key is used to establish the communication link.

17. The method of 15 further comprising:
storing network connectivity information in the USB device, wherein the network connectivity information is used to connect to the remote storage device.

18. The method of 15 further comprising:
obtaining a software patch for the USB device; and
updating internal information of the USB device based on the software patch.

19. The method of 15 further comprising:
obtaining a software patch for a terminal coupled to the USB interface; and
transmitting the software patch the terminal via the USB interface.

20. A processor configured to control operation of a USB device, comprising:
a universal serial bus (USB) interface;
a communication interface communicatively coupled to the USB interface; and
a processing circuit coupled to the USB interface and the communication interface, the circuit configured to
establish a secure communication link to a remote storage device over the communication interface, and
transmit data between the communication interface and USB interface to make the remote storage device appear as a local storage device over the USB interface.

21. A machine-readable medium having one or more instructions for operating a universal serial bus, which when executed by a processor causes the processor to:
provide identification information through a USB interface indicating that the USB device is a storage device;
establish a secure communication link to a remote storage device over a communication interface; and
transmit data between the communication interface and USB interface to make the remote storage device appear as a local storage device over the USB interface.

22. The machine-readable medium of 21 further having one or more instructions which when executed by a processor causes the processor to:
store internal configuration information for the USB device.

23. The machine-readable medium of 21 further having one or more instructions which when executed by a processor causes the processor to:
means for obtaining a software patch for the USB device; and
means for updating internal information of the USB device based on the software patch.

24. The machine-readable medium of 21 further having one or more instructions which when executed by a processor causes the processor to:
obtain a software patch for a terminal coupled to the USB interface; and
transmit the software patch the terminal via the USB interface.

25. A remote storage server configured to appear as a local storage device, comprising:
a storage media to store data; and
a communication interface configured to communicate with a remote USB device through which the remote storage server appears as a local storage device to another device coupled to the remote USB device,
wherein the communication interface sends information between the another device and the storage media.

26. The remote storage server of 25 wherein a communication link is transparently established between the communication interface and the remote USB device.
